(19) United States
(12) Patent Application Publication
(10) Pub. No.: US 2022/0390146 A1
(43) Pub. Date: Dec. 8, 2022

(54) FLOW HEATER WITH CALORIMETRIC FLOW SENSOR

(71) Applicant: BorgWarner Ludwigsburg GmbH, Ludwigsburg (DE)

(72) Inventors: Simon Frank, Bönnigheim-Hofen (DE); Damien Guerin, Stuttgart (DE); Alexander Dauth, Maulbronn (DE)

(21) Appl. No.: 17/825,898

(22) Filed: May 26, 2022

(30) Foreign Application Priority Data
Jun. 8, 2021 (DE) 10 2021 114 729.8

(51) Int. Cl. F24H 15/238; F24H 1/10; H05B 1/02; H05B 3/12; G01F 1/69

(52) U.S. Cl. CPC F24H 15/238; F24H 1/105; H05B 1/0236; H05B 1/0244; H05B 3/12; G01F 1/69; H05B 3/20

(57) ABSTRACT

A flow heater for vehicles is described. The flow heater has a housing, which has an inlet and an outlet. A flow channel for fluid to be heated is disposed in the housing and leads from the fluid inlet to the fluid outlet. A heating plate forms a wall of a heated section of the flow channel and carries an electric heating resistor. A calorimetric flow sensor is provided for measuring a fluid flow in the flow channel.

### RELATED APPLICATIONS

This application claims priority to DE 10 2021 114 729.8, filed Jun. 8, 2021, the entire disclosure of which is hereby incorporated herein by reference.

### BACKGROUND

This disclosure is based on a flow heater of the type generally disclosed by, for example, CN 210296571 U.

Flow heaters for vehicles contain an electrical heating resistor, with which a liquid can rapidly be heated. Unfavorable operating conditions, such as a rapid alteration of the flow rate, in particular if liquid stops flowing, can lead to overheating, which can cause damage, and in extreme cases may even start a fire.

Flow heaters in vehicles are therefore usually provided with temperature sensors that can detect any overheating, and can then reduce, or switch off, the heating power as necessary. As alternatives, or in addition, to temperature sensors, flow sensors can also be used to detect problematic alterations in the flow rate, and to adapt the heating power to the altered flow rate. In the flow heater of known art from CN 210296571 U, a flap is used as a flow sensor, which moves under the action of the flowing liquid.

### SUMMARY

This disclosure teaches how flow heaters for vehicles can be even better protected from any overheating, and with less effort.

In a flow heater according to this disclosure, a calorimetric flow sensor is used to determine how much liquid is flowing through the flow heater, so that the heating power can be reduced as necessary, and any overheating can be avoided. In comparison to a mechanical sensor, such as is of known art from CN 210286571 U, for example, a calorimetric flow sensor can be implemented at lower costs, and is also less susceptible to damage. A calorimetric flow sensor can be integrated into the flow heater at low cost, and enables a wide range of diagnostic options, as well as the detection of faults in a water circuit. In particular, a calorimetric flow sensor also enables a quick response to altered conditions, and does not increase differential pressure in the flow channel.

The calorimetric flow sensor comprises, as a sensor element, a sensor resistor, which in operation is heated with a predetermined electrical power, and is cooled by the liquid that flows through the flow heater. From the value of the electrical resistance of the sensor resistor, the temperature of the sensor resistor, and from this the fluid flow rate, can be determined.

The sensor resistor preferably has a different temperature dependence from that of the flow heater's heating resistor. For heating resistors, it is advantageous to have a temperature characteristic that is largely constant in the relevant temperature range of, for example, −40° C. to 100° C., and shows a sudden increase in the event of overheating. This is the case, for example, for ceramic PTC materials based on barium titanate. For the sensor resistor, on the other hand, a clear dependency of the electrical resistance over the entire temperature range that can occur in operation, is advantageous. An approximately linear temperature characteristic is particularly advantageous, as is usually the case for most metals, in particular for platinum.

In an advantageous refinement of this disclosure, provision is made for the sensor resistor to contain metal particles, for example of platinum or another metal.

In a further advantageous refinement of this disclosure, provision is made for the heating resistor to contain ceramic particles, for example, to be a mixture of ceramic and metal particles. The heating resistor preferably contains at least 10% by weight of ceramic particles.

In a further advantageous refinement of this disclosure, provision is made for the sensor resistor to be designed as a conductive track, for example on the housing, or on the heating plate.

In a further advantageous refinement of this disclosure, provision is made for the heating resistor to be designed as a conductive track. Both the heating resistor and the sensor resistor can, for example, be printed onto the heating plate at low cost, wherein different inks or pastes can be used for the heating resistor and the sensor resistor. In this way, a metallic sensor resistor, together with a partially, or predominantly, ceramic heating resistor, can be implemented at low cost.

In a further advantageous refinement of this disclosure, provision is made for the sensor resistor to be mounted closer to the fluid inlet of the housing than the heating resistor. In this way, the sensor resistor is cooled in operation by fluid that has not yet been heated, or only slightly heated, by the heating resistor. A greater sensitivity of the flow sensor can thereby advantageously be achieved.

In a further advantageous refinement of this disclosure, provision is made for the flow sensor to be used for temperature regulation, for example, in accordance with the following formula:

Pₑₗ=\dot{m}·c·ΔT

Here Pₑₗ is the electrical heating power, \dot{m} is the mass flow rate of the liquid to be heated, ΔT is the difference between the desired temperature at the outlet and the desired temperature at the inlet, and c is a material parameter of the liquid to be heated. Here, c can be a temperature-dependent variable whose current value is determined from a table stored in control electronics, or by means of a characteristic.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an illustrative embodiment of a flow heater for vehicles in a schematic exploded view; and

FIG. 2 shows a schematic sectional view of the flow heater.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

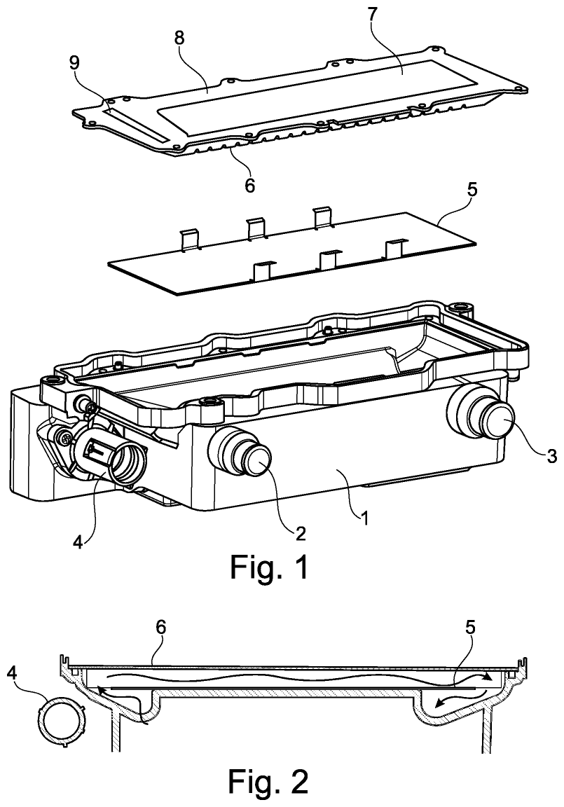

FIGS. 1 and 2 show schematically a housing 1 of a flow heater without a cover. The housing 1 has an inlet 2 for liquid to be heated and an outlet 3 for heated liquid, which can be provided with integrated, or separately inserted, connections for fluid lines, as shown in FIG. 1. The housing 1 carries electrical connectors 4, for purposes of connecting the flow heater to the electrical system of a vehicle. In other embodiments, the connectors may also be fitted to the housing cover, which is not shown.

A flow guide plate 5 and a heating plate 6 are arranged inside the housing 1. Fluid entering the housing 1 through the inlet 2 flows between the flow guide plate 5 and the heating plate 6, as indicated by arrows in FIG. 2, to the outlet 3. The heating plate 6 thus forms a wall of a heated section of the flow channel, which leads from the inlet 2 to the outlet 3.

The heating plate 6 comprises a substrate, for example a metal plate, which carries a heating resistor 7. The heating resistor 7 is preferably arranged on the dry side of the heating plate 6. In the embodiment shown, the heating plate 6 is a steel sheet that is covered with an insulation layer 8, on which the heating resistor 7, shown only schematically in FIG. 1, is designed in the form of conductive tracks, which can be arranged in a meandering pattern, for example.

The heating resistor 7 can, for example, be a resistive layer, which contains ceramic and metal particles, in particular contains at least 10% by weight of ceramic particles. The heating resistor 7 can thus be printed on as a paste at low cost.

The heating plate 6 also carries a sensor resistor 9, which is also only shown schematically in FIG. 1. The sensor resistor 9 may be a conductive track of metal, for example of platinum. The sensor resistor 9 can also be printed on, for example by using a suitable platinum ink or similar.

For purposes of making contact with the heating resistor 7 and the sensor resistor, a printed circuit board with control electronics can be used, arranged, for example, above the heating plate 6, which is not shown in FIG. 1, and can be integrated in the cover, for example.

The sensor resistor 9 forms a calorimetric flow sensor, with which the quantity of liquid flowing from the inlet 2 to the outlet 3 can be determined. In operation, the sensor resistor 9 is heated with a predetermined electrical power, and is cooled by the liquid flowing past the heating plate. The temperature of the sensor resistor 9 thus depends on the flow rate. From the instantaneous electrical resistance of the sensor resistor 9, its temperature and thus the flow rate can be determined, using its resistance-temperature characteristic.

If the flow rate of the liquid to be heated falls below a critical threshold, a control device can reduce, or completely switch off, the electrical power of the heating resistor 7 to prevent any overheating.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Housing
2 Inlet
3 Outlet
4 Connector
5 Flow guide plate
6 Heating plate
7 Heating resistor
8 Insulation layer
9 Sensor resistor

What is claimed is:

1. A flow heater for vehicles, comprising:
a housing having an inlet and an outlet;
a flow channel configured for liquid to be heated and leading from the inlet to the outlet;
a heating plate forming a wall of a heated section of the flow channel, the heating plate carrying an electrical heating resistor; and
a calorimetric flow sensor configured for measuring a flow in the flow channel.

2. The flow heater according to claim 1, wherein the flow sensor comprises a sensor resistor as a sensor element, which is formed as a conductive track.

3. The flow heater according to claim 2, wherein the conductive track is arranged on the housing.

4. The flow heater according to claim 2, wherein the conductive track is arranged on the heating plate.

5. The flow heater according to claim 2, wherein the conductive track is a printed conductive track.

6. The flow heater according to claim 2, wherein the conductive path contains metal particles.

7. The flow heater according to claim 2, wherein the heating resistor is a conductive track.

8. The flow heater according to claim 7, wherein the heating resistor is a conductive track, which contains ceramic particles.

9. The flow heater according to claim 1, wherein the flow sensor is connected to a control device, which switches off the electrical heating resistor if the measured flow drops below a predetermined threshold value.

10. The flow heater according to claim 1, wherein the flow sensor is located closer to the inlet than the heating resistor.
